(19) United States
(12) Patent Application Publication
(10) Pub. No.: US 2002/0005973 A1
(43) Pub. Date: Jan. 17, 2002

(54) Process for transmitting optically coded signals, a system and an optical signal processor

(75) Inventor: Thomas Pfeiffer, Stuttgart (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 09/897,402

(22) Filed: Jul. 3, 2001

(30) Foreign Application Priority Data
Jul. 17, 2000 (DE) 100 35 074.7

(51) Int. Cl. H04B 10/12; H04B 10/04

(52) U.S. Cl. 359/173; 359/181

(57) ABSTRACT

A process for the transmission of optically coded signals and a system for the transmission of optically coded signals are proposed. By the use of an optical signal processor, a modified signal is generated which facilitates the use of simple optical receivers.

### BACKAROUND OF THE INVENTION

The invention is based on a priority application DE 100 35 074.7 which is hereby incorporated by reference.

The invention is based on a process for transmitting optically coded signals comprising the following steps: spectral coding of optical signals in transmitters, transmission of the spectrally coded signals via a transmission link, inversion of the superposition signal, optical addition of the superposition signal with the inverted signal to form a sum signal, and analysis of the sum signal in an optical receiver.

The invention is further based on a system for transmitting optically coded signals. This system consists of transmitters for the transmission of optically coded signals, transmission links and optical receivers with decoders for optical coded signals. The invention is further based on an optical signal processor in a transmission system for coded optical signals.

A process and system for the transmission of optical coded signals is known for example from DE OS 197 23 103.9. An optical transmission system for the transmission of optical coded signals contains transmitters, transmission links and receivers. Each transmitter contains a coder in which the signals to be transmitted are coded prior to their transmission into the optical transmission system. The coding is performed optically, for example by frequency coding using an optical filter. Each receiver in the transmission system wishing to receive the optical signals transmitted from the transmitter must contain a decoder which is tuned to a special coder of a transmitter. In the simplest case the frequency ranges which are conductive for optical signals and the frequency ranges which are blocked for optical signals are the same in the case of the coder in the transmitter and the decoder in the receiver. These multipoint-to-multipoint transmission systems are known under the term CDM (code division multiplex). In the prior art the receivers in a CDM transmission system are constructed as differential receivers. Only in this way is it possible to eliminate the cross-talk effects which occur in a CDM transmission process. The demands on the differential receivers are correspondingly high and lead to costly equipment. Thus DE-OS 197 48 756 has disclosed a differential receiver wherein the two optical branches of the receiver are adapted to one another in costly manner. This costly construction of the receiver for use in a CDM system limits the bit rate for a transmission channel to below 1 Gbit/s due to different characteristics of the components. Further adaptations which would be necessary in order to increase the bit rate lead to a greater outlay and further costs for the production of a receiver.

### SUMMARY OF THE INVENTION

Therefore the object of the invention is to propose a CDM transmission process and a CDM system in which the outlay which must be expended in the receivers is distinctly reduced. By converting the coded optical signals into a sum signal the process according to the invention makes available an optical signal which can be analyzed by a simple optical receiver. The system according to the invention is extended by an optical signal processor which modifies the optical coded signals such as to facilitate the use of simple optical receivers.

Advantageously the optical signal processor comprises means for receiving a superposition signal consisting of coded transmitted signals. It also contains means for inverting the superposition signal, means for adding the superposition signal and the inverted signal, and means for transmitting this sum signal across the transmission link. In a particularly advantageous embodiment the optical signal processor consists of an emitter for ASE (amplified spontaneous emission) and a reflector, and of an adjoining coupler for the two signals occurring in the optical branches.

Another advantageous embodiment uses an emitter for ASE specially designed for the requirements as optical signal processor, with a high output level of ASE at a low input power level of the superposition signal and with a low output level at a high input power level of said signal. Another embodiment employs an opto-electrical conversion means, an inversion means and an optical transmitter to recombine the converted signal with the original signal which is temporally adapted to the processed signal.

### BRIEF DESCRIPTION OF THE DRAWINGS

Exemplary embodiments of the invention are illustrated in the figures and explained in detail in the following description. In the drawing:

FIG. 1 illustrates a plan of a CDM transmission system;

FIG. 2 illustrates the signals in the CDM transmission system;

FIG. 3 illustrates the resultant signal following decoding in the receiver and

FIGS. 4a to 4c illustrate embodiments of an optical signal processor.

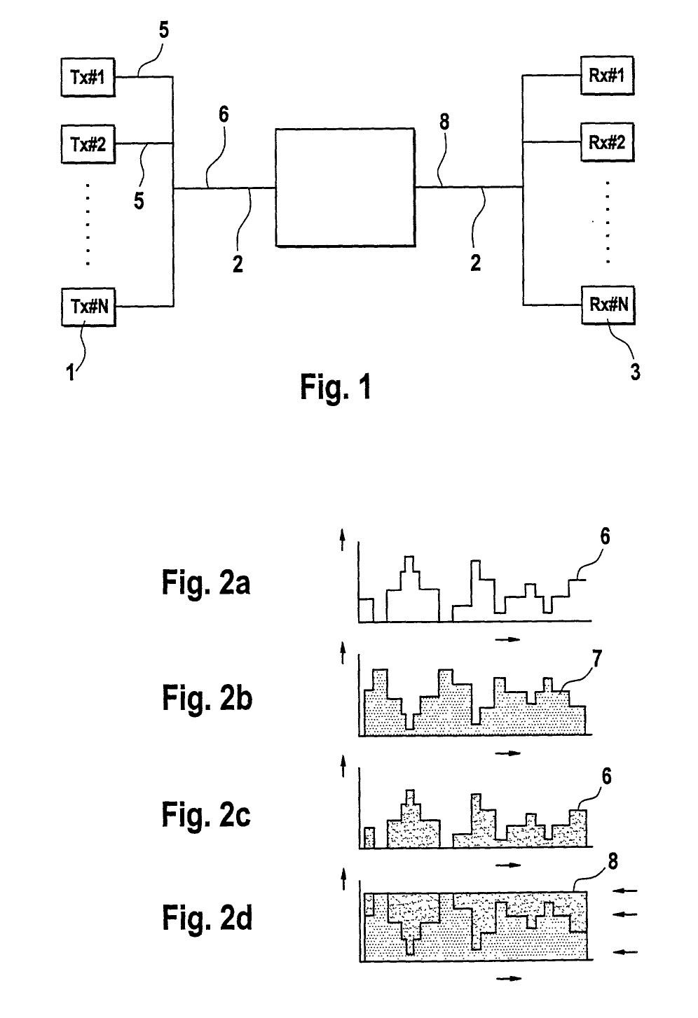

FIG. 1 illustrates the plan of a multipoint-to-multipoint connection using the CDM process. A plurality of transmitters 1 are provided. These transmitters are connected to a transmission link 2. An optical signal processor 4 is integrated into the transmission link. At the receiving end receivers 3 are connected to the transmission link 2. FIG. 2 illustrates how the optical signals change in the course of the transmission process. Each transmitter 1 transmits a coded optical signal 5. These coded optical signals are combined for transmission via the transmission link 2. They are superposed upon one another undisturbed to form a superposition signal 6 of coded signals. The resultant signal is illustrated in FIG. 2a as intensity over a time axis. The superposition signal 6 enters the optical signal processor 4. Here an inverted signal 7 is generated. The inverted signal contains no coding information but merely inverts the intensity of the superposition signal 6. The inverted signal 7 is illustrated in FIG. 2b. The inverted signal 7 is added to the superposition signal 6 as illustrated in FIG. 2c. The resultant sum signal 8, shown in FIG. 2d, contains the complete coding information of the original superposition signal 6. The sum signal 8 which issues from the optical signal processor 4 no longer contains any intensity modulation. This no longer intensity-modulated signal is forwarded via the transmission link 2 and reaches the receivers 3. In the receiver 3 the sum signal 8 passes through a decoder wherein all the channels whose coding does not match the decoding of the receiver are allowed through with a constant power level. For the channels whose coding does not match the decoding of the receiver, a spectrally coded “1” is transmitted with a specific power level. As the optical processor also supplies the same signal level in the case of a “0”, the same power level is also transmitted in the receiver. Only the channel with the matching coding generates an output signal which is somewhat greater in the case of a “1” than in the case of a “0”. In the receiver downstream of the decoder a constant optical power level is obtained as the sum of the channels, with additional small power pulses which belong to the decoded channel in the case of a coded “1”. This signal structure can be processed by conventional receivers.

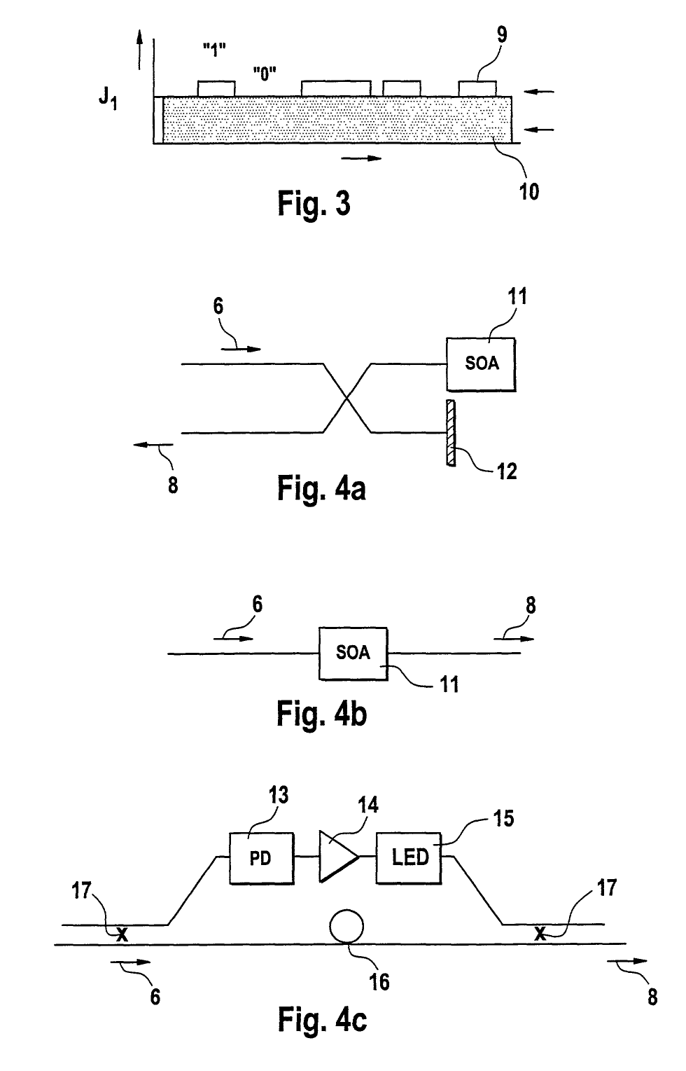

The resultant signal is illustrated in FIG. 3. The basic signal 10, i.e. the sum of the unmatched channels, supplies a constant optical power with an intensity l1. Observable in the basic power l1 are power increases 9 which correspond to a “11” for the decoded channel. Here the basic power l1 corresponds to a “0” for the decoded channel. The cross-talk problems of the optical channels are distinctly reduced by the use of the optical signal processor.

In another embodiment the sequence of the process is changed. The optical signal processor is directly connected to the individual transmitters 1. In this way a coded optical signal 5 is inverted with optical signal processors 4 and added to the output signal. These individual, processed signals are then combined and transmitted across the transmission line 2.

In another embodiment, optical signal processors are arranged directly upstream of the individual receivers. Then the superposition signals are inverted, added to one another and analyzed in the receiver.

Different embodiments of optical signal processors are used.

FIG. 4a illustrates an embodiment with an emitter for broadband ASE (amplified spontaneous emission). At the input end the superposition signal 6 is applied both to the emitter l1 and to a reflector 12. Such an emitter for spontaneous amplified emission is described in application DE 100 13718.0. A semiconductor amplifier is used for example as emitter. The semiconductor amplifier is excited with a constant operating current so that a constant ASE is emitted. The emission is constant for such time as no optical signal is applied to the semiconductor amplifier. If a coded 1 arrives via the transmission link, the ASE of the semiconductor amplifier is reduced. If, at the input end, a small signal, for example a “0”, is present in the superposition signal 6, the semiconductor amplifier emits its maximum of ASE. The emitted ASE power is inverted relative to the input power. The thus inverted ASE power is coupled with the reflected spectrum and thus superposed to form a sum signal.

In the embodiment illustrated in FIG. 4b a semiconductor amplifier which has a high background noise in the form of ASE is used for example as emitter for ASE. At the same time the semiconductor amplifier is adjusted such that it amplifies the transmitted signal only to a small extent. If an optical signal with a high power level is applied to the semiconductor amplifier, it emits only a small proportion of ASE, while the semiconductor amplifier generates a large proportion of ASE in the case of a large optical signal. If the semiconductor amplifier is optimally adjusted, this results in a quasi-constant output power.

The embodiment according to 4c shows another implementation of the optical signal processor. The superposition signal 6 is split at the input end in a branching 17. In a first optical branch the signal passes through a photo-diode 13 and an inverter 14 and is coupled into the optical branch again via a LED 15. The second optical branch contains a delay line 16. The two optical branches are coupled in a further branching 17. In this embodiment the optical signal is electrically converted, amplified, inverted and possibly processed. Then the optical signal is fed as intensity-modulated signal to a broadband optical source, for example a LED. The inverted signal of the branch and the original signal, temporally adapted, in the other optical branch are superposed via the branching 17.

In another advantageous embodiment a laser is used instead of a broadband LED 15 as transmitter in the arrangement according to FIG. 4c. Here the laser preferably transmits outside the useful range of the transmission band. An example wavelength would be 1300 nm laser emission using the 1500 nm band for the transmission. In such an embodiment the filters in the receivers are transparent for the laser wavelength.

In another embodiment the processing of the converted optical signal takes place in a plurality of steps. The resultant sum signal here is analyzed for its “quality”. The resultant signal is to approximate the ideal state of the sum signal 8 as far as possible. If the analysis indicates a negative result, the processing of the signal is repeated. In another embodiment, an improvement in the signal quality, such as for example by amplification, recovery of the signal structure, of the signal clock etc., also takes place in at least one signal branch.

The proposed invention at the same time reduces problems with noise in the optical channel. As the noise components are present both in the original superposition signal and in the inverted signal, in the process according to the invention they are averaged out and no longer constitute a problem for the detection of the signal.

1. a process for transmitting optically coded signals comprising the following steps:
spectral coding of optical signals in the transmitters,
inversion of the optically coded signals,
optical addition of the optically coded signals to the inverted signals to form a sum signal,
transmission of the sum signal via a transmission link,
analysis of the sum signal with an optical decoder in the receiver.

2. A system for transmitting optically coded signals comprising transmitters for the transmission of optically coded signals, transmission links, and optical receivers which contain decoders for the optically coded signals, wherein at least one optical signal processor is contained in the transmission system, which signal processor superposes the transmitted coded optical signals with an inverted signal and forwards the sum signal for the analysis in the receivers.

3. An optical signal processor in a CDM transmission system comprising
means for the reception of coded signals,
means for the inversion,
means for the addition of the optically coded signals and the inverted signals and
means for the transmission of the sum signals.

4. An optical signal processor according to claim 3 with an emitter for ASE (amplified spontaneous emission) and a reflector, wherein the reflected signal of the reflector and the ASE signal of the emitter are added by a coupler to form a sum signal.

5. An optical signal processor according to claim 3 with an emitter for ASE with a high ASE-output level at a low power level of the superposition signal and with a low ASE-output level at a high power level of the superposition signal.

6. An optical signal processor with a first signal branch in which the optical signal is converted into an electrical signal and is processed such that the signal represents the inverted original signal, and with a second signal branch from which the original signal is made available in synchronism with the inverted signal.

7. An optical signal processor according to claim 3, with at least one branching with a delay line in one optical branch and with an opto-electric converter, an inversion means and an optical transmitter in the second optical branch, and with a second branching for coupling the signals of the two optical branches.
